(19) United States
(12) Patent Application Publication
(10) Pub. No.: US 2015/0015545 A1
(43) Pub. Date: Jan. 15, 2015

(54) POINTING INPUT SYSTEM HAVING SHEET-LIKE LIGHT BEAM LAYER

(71) Applicant: Micro-Nits Co., Ltd., Miaoli County (TW)

(72) Inventor: LI-WEN TING, Miaoli County (TW)

(21) Appl. No.: 14/504,049

(22) Filed: Oct. 1, 2014

Related U.S. Application Data
(63) Continuation-in-part of application No. 12/785,689, filed on May 24, 2010, now abandoned.

(30) Foreign Application Priority Data
May 25, 2009 (TW) 098117270

(51) Int. Cl. G06F 3/03

(52) U.S. Cl. CPC G06F 3/0308
USPC 345/175

(57) ABSTRACT

A pointing input system includes a sheet-like light beam layer and a detector. The sheet-like light beam layer abuts a display screen and is distributed on a surface of a display screen, and includes plural light beams. The sheet-like light beam layer is generated by at least one light-generating module having a dot light source. The detector is for detecting a light spot composed of plural reflective beam when a physical object is intervened into the sheet-like light beam layer, so that a pointing input operation is performed on a specified position of the display screen corresponding to the light spot. Once the physical object is intervened into the sheet-like light beam layer, the light beams are sheltered by the physical object, so that the light spot with a reflective bright border is resulted from a touching action of the physical object.

### REFERENCE TO RELATED APPLICATION

The present application is a continuous-in-part application of U.S. patent application Ser. No. 12/785,689, filed on May 24, 2010 and entitled POINTING INPUT SYSTEM HAVING SHEET-LIKE LIGHT BEAM LAYER.

### FIELD OF THE INVENTION

The present invention relates to a pointing input system, and more particularly to a pointing input system having a flat or curve light beam layer.

### BACKGROUND OF THE INVENTION

With rapid development of the pointing input technology, it is important to provide a pointing input system with a more simplified, responsible and interactive input operating interface.

FIGS. 1A, 1B and 1C are schematic diagrams illustrating three types of pointing input devices according to the prior art.

As shown in FIG. 1A, the conventional pointing input device 10 comprises a display screen 12 (e.g. a projection screen, LCD display, TV, Plasma TV), a rear/front projection type projector 13 and a detector 14 (e.g. an image capture device or an optical receiver). The projector 13 has a projecting beam range between the boundary lines I11, and the detector 14 has a detecting beam range between the boundary lines I12, wherein I11, I12 may or may not have the same size.

When a user 11 uses a laser pointer or a pointing stick (not shown) to transmit an indication point to a specified position X1 of the projection screen 12 via a transmitting action M (e.g. a projecting action or a directing action), the indication point is detected by the detector 14. Then, image signal comparison and image analysis are performed by a host (not shown), which is electrically connected to the projector 13 and the detector 14. As such, the coordinate value corresponding to the specified position X1 is realized. After the coordinate value is realized, the host will perform a pointing input operation on the specified position X1 of the projection screen 12.

FIG. 1B schematically illustrates another type of conventional pointing input device. As shown in FIG. 1B, the conventional pointing input device 20 comprises a display screen 21 and two detectors 22 and 23, which are respectively arranged on left and right corners of the screen 21. These two detectors 22 and 23 may be video cameras. For example, the display screen 21 is a screen of the common electronic appliance such as a television, a LCD television, a plasma television, a handwriting board, a handheld device, or the like.

A common operating method of the pointing input device 20 will be illustrated with reference to FIG. 1B. When a user places an actively-illuminating light pen (not shown) on a specified position X2 of the display screen 21, a light spot is detected by the video cameras 22 and 23. Then, image signal comparison and image analysis are performed by a host (not shown), which is electrically connected to the display screen 21 and the two video cameras 22 and 23. As such, the coordinate value corresponding to the specified position X2 (i.e. the real position of the light spot) is realized. After the coordinate value is realized, the host will perform a pointing input operation on the specified position X2 of the display screen 21.

Another common operating method of the pointing input device 20 will be also illustrated with reference to FIG. 1B. As shown in FIG. 1B, two additional light-emitting bars 24 and 25 are disposed on both edges of the display screen 21. In addition, the detectors 22 and 23 are replaced by optical receivers in order to continuously receive the light beams I21 that are emitted from the light-emitting bars 24 and 25. When any physical object enters the coverage range of the light beams emitted from the light-emitting bars 24 and 25, some of the light beams are hindered and sheltered by the physical object and fail to be received by the optical receivers 22 and 23. After the physical object is detected by the optical receivers 22 and 23, image signal comparison and image analysis are performed by a host (not shown), which is electrically connected to the display screen 21 and the two optical receiver 22 and 23. As such, the coordinate value corresponding to the specified position X2 (i.e. the sheltered position) is realized. After the coordinate value is realized, the host will perform a pointing input operation on the specified position X2 of the display screen 21.

FIG. 1C schematically illustrates another type of conventional pointing input device. As shown in FIG. 1C, the conventional pointing input device 30 comprises a display screen 31, plural light-emitting elements 32 and plural light-receiving elements 33. The light-emitting elements 32 are arranged at the upper side and the left side of the display screen 31. The light-receiving elements 33 are arranged at the lower side and the right side of the display screen 31. The light-emitting elements 32 are aligned with respective light-receiving elements 33. As such, the light beams I31 emitted from the light-emitting elements 32 are continuously received by the corresponding light-receiving elements 33.

For example, the display screen 31 is a screen of the common electronic appliance such as a television, a LCD television, a plasma television, a handwriting board, a handheld device, or the like. When a physical object (e.g. a user's finger or a stick-like article) is placed on a specified position X3 of the display screen 31, some of the light beams emitted from the light-emitting elements 32 are sheltered by the physical object and fail to be received by some of the optical receivers 33. As such, the coordinate value corresponding to the specified position X3 could be realized. After the coordinate value is realized, a pointing input operation is performed on the specified position X3 of the display screen 31 by the host, which is electrically connected to the display screen 31.

From the above discussions, according to the conventional technologies, the accurate pointing input position is determined by detecting the indication point from the actively-illuminating light pen or detecting the region sheltered by the physical object. The conventional methods, however, are not intuitively sensed or directly perceived. Especially when a touching action is performed, the user usually fails to sense the touching feel.

Besides, in US Patent Application Publication No. 2011/0128234, Lipman et al. disclose an integrated display and input device including a pixel array operative to provide a visual sensible output, which the display, pixel array and sensor are integrated into a housing for a portable device. However, the light detector elements disclosed by Lipman et al. are interspersed among light emitters which emit lights to form pixel array, and are arranged in a same plane together with the light emitters for the integration consideration, thus the arrangement of the light detector is restricted.

Moreover, in US Patent Application Publication No. 2008/0013913, Lieberman et al. also disclose an optical touch panel including a support, an optical fiber illumination assembly arranged along and above at least part of periphery of the support to define a detection region. Similar to Lipman's disclosure, Lieberman et al. disclose an integrated housing including all components therein. Besides, the detectors disclosed by Lieberman et al. detects changes in the light received from an optical fiber illumination assembly produced by the presence of a finger or stylus in the detection region, which compares the received light differences between with or without the presence of the finger. However, provided that one or more displays, sensors, or detection region are intended to scale up, there are various factors to be considered. For example, it may be suitable for a small-size integrated devices or apparatus to use LED light source and detect lights from LED light source in Lipman or Lieberman's disclosures as signal detection. However, in fact, LED light source is one to emit relatively diversified lights among light-emitting sources. When applied to a display surface in big sizes, most of lights from LED light source not well constrained will be splashed on the display surface and reflect randomly into a detector to cause significant noises. Furthermore, it is a significant issue for LED light to be detectable after one or more reflections. In this regard, such as a device or apparatus like Lipman or Lieberman may not be suitable to be scaled up into a big-size apparatus or system.

For obviating the drawbacks encountered from the conventional touch input technology, there is a need of providing an improved pointing input device.

### SUMMARY OF THE INVENTION

An object of the present invention provides a pointing input system having a sheet-like light beam layer. When a physical object is intervened into the light beam layer, a light spot with a reflective bright border is resulted from a touching action of a physical object, so that the touching action becomes conspicuous.

In accordance with an aspect of the present invention, there is provided a pointing input system. A pointing input system, applied to a display screen, comprising: a sheet-like light beam layer abutting the display screen and distributed on a surface of the display screen, wherein said sheet-like light beam layer comprises plural laser light beams emitted by a laser-generating module; and a detector locates at a position subject to prevent from receiving said laser light beams from said laser-generating module, wherein when a physical object is intervened into said sheet-like light beam layer to form a light spot composed of plural reflective beams by sheltering said laser light beams of said sheet-like beam layer, said detector detects said light spot for detecting a pointing position with respect to said display screen.

In an embodiment, the sheet-like light beam layer is flat or curve.

In an embodiment, wherein said laser-generating module abutting a specified corner of said display screen, or wherein said two laser-generating modules respectively arranged on a left corner and a right corner of said display screen, or respectively arranged at one of an upper side and a lower side of said display screen and one of a left side and a right side of said display screen.

In an embodiment, said laser-generating module comprises: a plurality of laser light sources abutting said surface of said display screen to generate a plurality of source laser beams; and an optical path adjusting mechanism arranged corresponding to said laser light sources for reflecting and/or refracting said source laser beams, thereby generating said laser light beams of said sheet-like light beam layer.

In an embodiment, said optical path adjusting mechanism comprises plural beam splitters arranged in parallel with each other, so that said source laser beams are successively transmitted through and reflected by said beam splitters to generate said laser light beams, or wherein said optical path adjusting mechanism comprises a polygonal reflective mirror, which is rotated to reflect said source laser beams, thereby generating said laser light beams, or wherein said optical path adjusting mechanism comprises a single-surface reflective mirror, which is rotated to reflect said source laser beams, thereby generating said laser light beams, or wherein said optical path adjusting mechanism comprises a meniscus concave-convex lens.

In an embodiment, said sheet-like light beam layer has an even thickness in a range of 1 to 5 mm, and a diagonal dimension of 30 to 300 inches.

In an embodiment, a flat or curve reflective minor is deposited in front of said sheet-like light beam layer to receive said plural reflective beams and transmit said plural reflective beams to said detector.

In an embodiment, said detector comprises a single video camera in front of said sheet-like beam layer to be not aligned along with said laser light beams of said sheet-like beam layer such that said video camera does not detect said plural laser light beams emitted by said laser-generating module.

In an embodiment, said sheet-like light beam layer is a flat sheet-like light beam layer.

In an embodiment, wherein said laser-generating module comprising plural laser light sources abutting a specified corner of said display screen and generating plural source laser beams, or wherein said two laser-generating modules respectively comprising plural laser light sources to be arranged on a left corner and a right corner of said display screen, or respectively arranged at one of an upper side and a lower side of said display screen and one of a left side and a right side of said display screen.

In an embodiment, an optical path adjusting mechanism is arranged corresponding to said laser light sources for reflecting and/or refracting said source laser beams, thereby generating said laser light beams of said sheet-like light beam layer.

In an embodiment, a flat or curve reflective minor is deposited in front of said sheet-like light beam layer to receive said plural reflective beams and transmit said plural reflective beams to said single video camera, wherein for a vertical distance with respect to said sheet-like light beam layer, said single video camera is shorter than said flat or curve reflective minor.

In an embodiment, said sheet-like light beam layer is a curve sheet-like light beam layer and said display screen is a curve display screen.

In an embodiment, said laser-generating module comprises plural laser light sources respectively arranged along with one or two curve edges of said curve display screen.

In an embodiment, an optical path adjusting mechanism arranged corresponding to said laser light sources for reflecting and/or refracting said source laser beams, thereby generating said laser light beams of said sheet-like light beam layer.

In an embodiment, a flat or curve reflective mirror deposited in front of said sheet-like light beam layer to receive said plural reflective beams and transmit said plural reflective beams to said single video camera, wherein for a vertical distance with respect to said sheet-like light beam layer, said single video camera is shorter than said flat or curve reflective mirror.

In an embodiment, said physical object includes a finger, multiple fingers or a stick-like article.

In an embodiment, said display screen is a handwriting board screen, a multi-screen video wall or a projection screen.

In an embodiment, when said pointing input operation is performed, pointing information associated with mouse left/right button, light spot position, light spot size and/or touching pressure is simultaneously identified and inputted.

In an embodiment, said pointing position detected by said detector is implemented by a distortion correction with respect to said display screen.

The above objects and advantages of the present invention will become more readily apparent to those ordinarily skilled in the art after reviewing the following detailed description and accompanying drawings, in which.

### BRIEF DESCRIPTION OF THE DRAWINGS

FIGS. 1A, 1B and 1C are schematic diagrams illustrating three types of pointing input devices according to the prior art;

FIG. 2A is a schematic side view illustrating a pointing input device according to a first embodiment of the present invention before a touch input operation is performed;

FIG. 2B is a schematic side view illustrating the pointing input device according to the first embodiment of the present invention after the touch input operation is performed;

FIGS. 3A˜3F are schematic diagrams illustrating several examples of the light-generating module for generating the sheet-like light beam layer as shown in FIGS. 2A and 2B;

FIG. 4 is a schematic side view illustrating a pointing input device according to a second embodiment of the present invention before a touch input operation is performed;

FIG. 5 is a schematically top-view diagram illustrating an exemplary pointing input system applied to short throw or ultra short throw projection environment.

FIG. 6 is a schematically top-view diagram illustrating an exemplary pointing input system applied to large-scale projection environment.

FIG. 7 is a schematically top-view diagram illustrating an exemplary pointing input system applied to large-scale display environment.

FIG. 8 is a front-view diagram of a display screen and a light-generating module shown in FIG. 7.

FIG. 9 is a schematically side-view diagram illustrating a portion of an exemplary pointing input system equipped with an optical path adjusting mechanism according to the present invention.

FIG. 10 is a schematically top-side through view diagram illustrating a portion of an exemplary pointing input system equipped with an optical path adjusting mechanism and a curve display according to the present invention.

FIG. 11 is a schematically diagram illustrating the distortion correction according to the present invention.

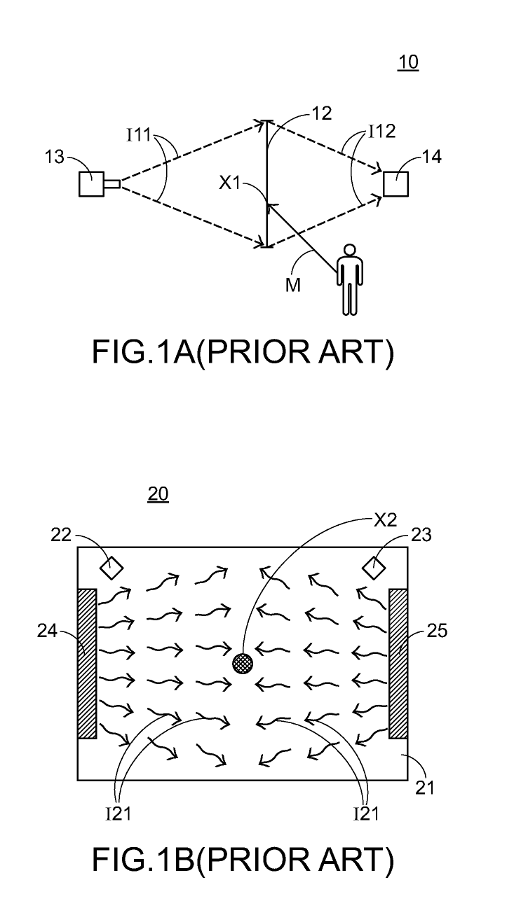

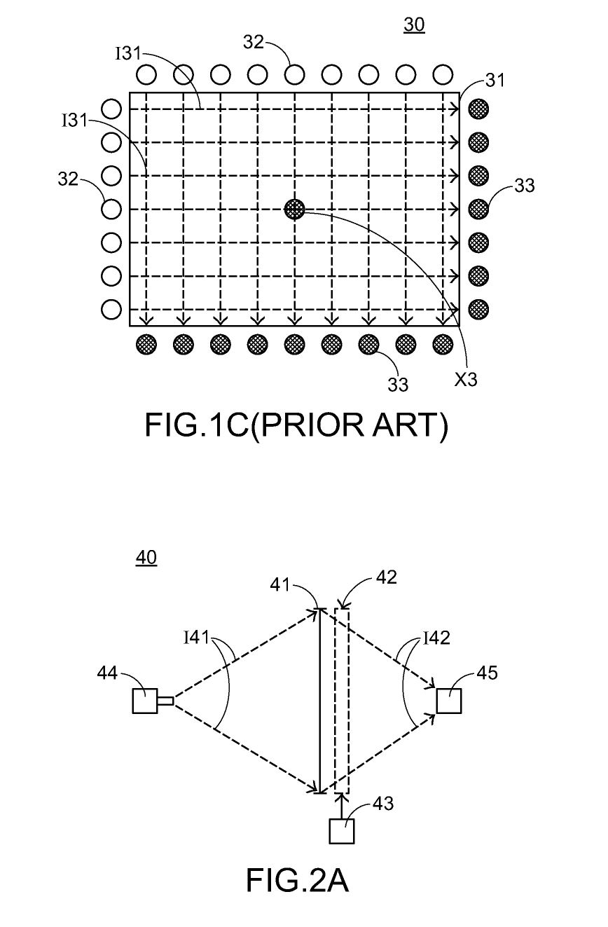

### DETAILED DESCRIPTION OF THE PREFERRED EMBODIMENT

It is to be noted that the following descriptions of preferred embodiments of this invention are presented herein for purpose of illustration and description only. It is not intended to be exhaustive or to be limited to the precise form disclosed.

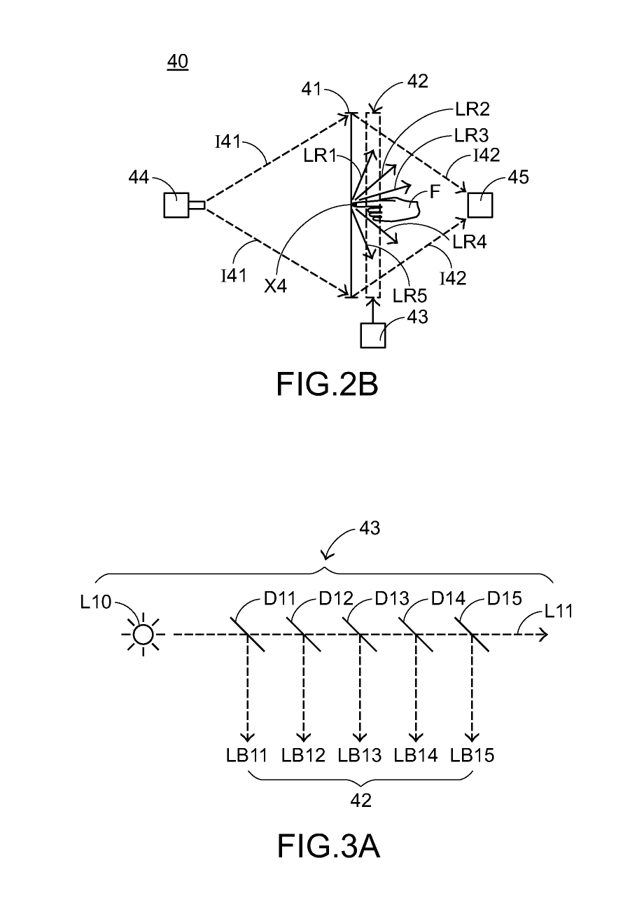

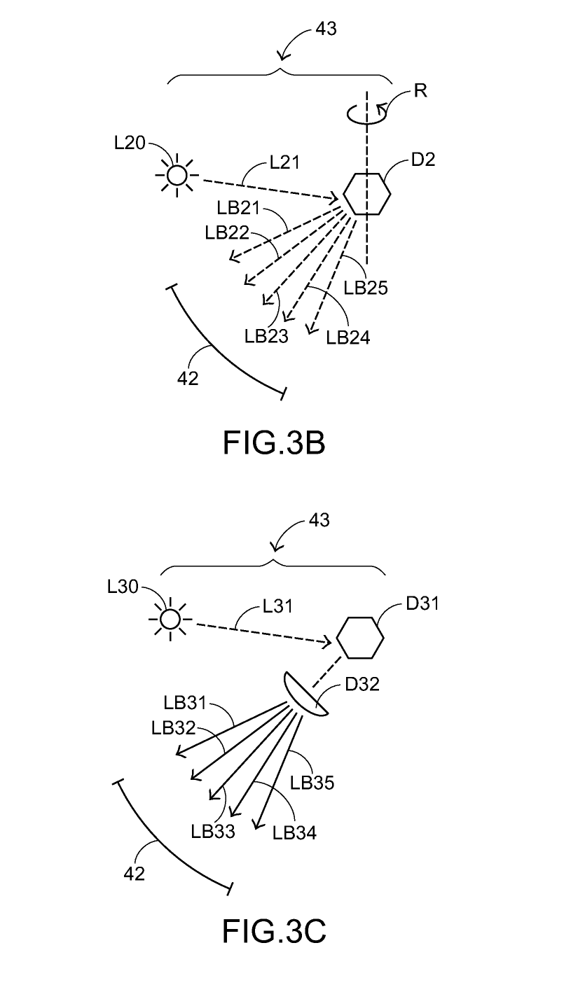

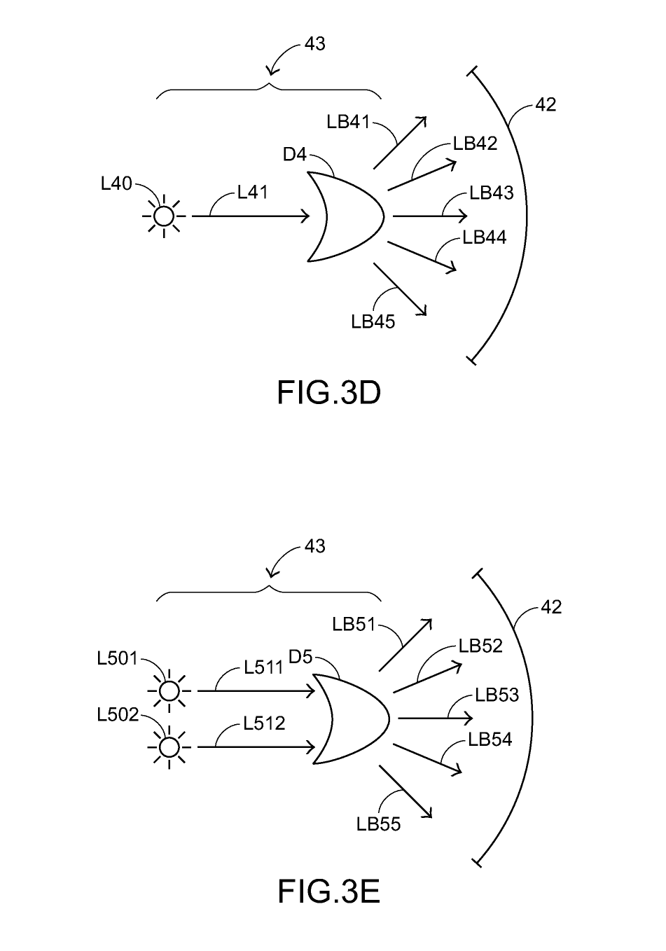

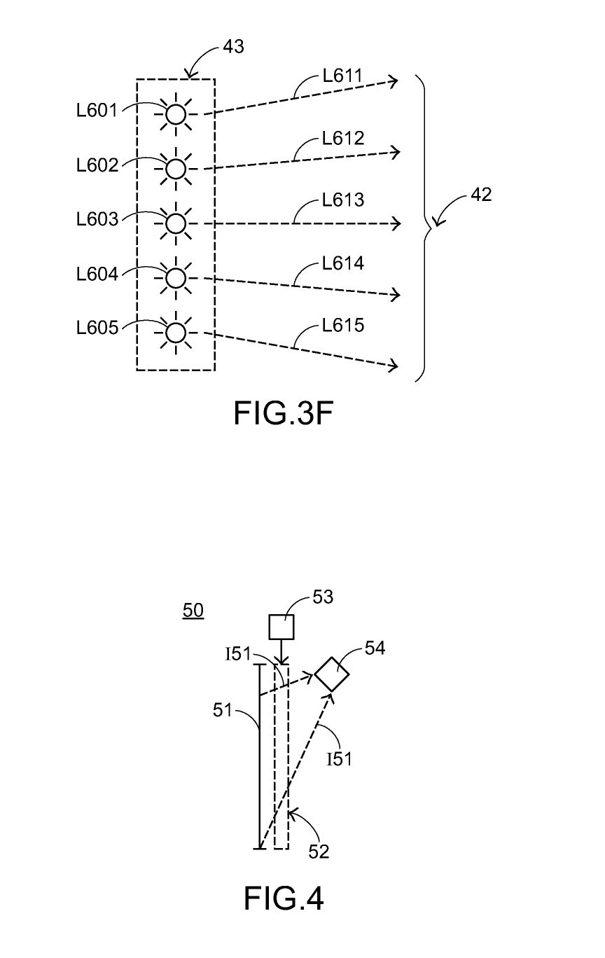

FIG. 2A is a schematic side view illustrating a pointing input system according to a first embodiment of the present invention before a touch input operation is performed. FIG. 2B is a schematic side view illustrating the pointing input system according to the first embodiment of the present invention after the touch input operation is performed. As shown in FIGS. 2A and 2B, the pointing input system 40 comprises a side-looking display screen 41, a flat or curve sheet-like light beam layer 42 including plural light beams, a light-generating module 43 for generating the sheet-like light beam layer 42, a projector 44 and a detector 45 (e.g. a video camera, a linear array or an optical receiver). The configurations and positions of the light-generating module 43 and the method of generating the light beams by the light-generating module 43 will be illustrated with reference to FIGS. 3A˜3F. In addition, the projector 44 has a projecting beam range between the boundary lines I41, and the detector 45 has a detecting beam range between the boundary lines I42.

The sheet-like light beam layer 42 abuts the display screen 41 and distributed on the surface of the display screen 41. The specified design should assure that, before a physical object F enters the sheet-like light beam layer 42 (see FIG. 2B), none of obvious light beams coming from the action region are received or captured by the detector 45. On the other hand, once the physical object F is intervened into the sheet-like light beam layer 42, the interference between the physical object F and the sheet-like light beam layer 42 results in a light spot, which is composed of several reflective beams LR1˜LR5. After a specified position X4 of the display screen 41 corresponding to the light spot is realized, a pointing input operation is performed on the specified position X4. In other words, once the physical object F is intervened into the sheet-like light beam layer 42, these light beams are sheltered by the physical object F, so that the light spot with a reflective bright border is resulted from the touching action of the physical object F.

Moreover, the physical object F includes for example a finger (see FIG. 2B), multiple fingers or a stick-like article (not shown). An example of the display screen includes but is not limited to a computer screen, a television screen, a handheld device screen, a handwriting board screen, a multi-screen video wall or a projection screen.

FIGS. 3A˜3F are schematic diagrams illustrating several examples of the light-generating module 43 for generating the sheet-like light beam layer 42. As shown in FIGS. 3A˜3D, the light-generating module 43 includes a single light-emitting element and an optical path adjusting mechanism, and the light-generating module is disposed beside the display screen 41. As shown in FIGS. 3E and 3F, the light-generating module 43 includes two light-emitting elements. Alternatively, the light-generating module 43 includes a single light-emitting element and an electrically-rotating driving device (not shown). It is noted that, however, those skilled in the art will readily observe that numerous modifications and alterations may be made while retaining the teachings of the invention.

Please refer to FIGS. 3A˜3E, 2A and 2B again. The light-generating module 43 comprises one or more light-emitting elements (L10, L20, L30, L40, L501˜L502) and an optical path adjusting mechanism (D11˜D15, D2, D31˜D32, D4, D5) corresponding to the light-emitting elements (L10, L20, L30, L40, L501˜L502). The light-emitting elements (L10, L20, L30, L40, L501˜L502) are arranged beside the surface of the display screen 41 and serve as dot light sources for generating one or more source light beams (L11 L21, L31, L41, L511˜L512), Due to reflection or refraction of the optical path adjusting mechanism (D11˜D15, D2, D31˜D32, D4, D5), the sheet-like light beam layer 42 with the light beams (LB11˜LB15, LB21˜LB25, LB31˜LB35, LB41˜LB45, LB51˜LB55) are generated. In this embodiment, the source light beams (L11 L21, L31, L41, L511˜L512) are visible light beams or invisible light beams. For example, the source light beams (L11 L21, L31, L41, L511˜L512) are visible laser beams or infrared laser beams.

The configurations of the light-generating module 43 for generating the light beams (LB11˜LB15, LB21˜LB25, LB31˜LB35, LB41˜LB45, LB51˜LB55) are somewhat distinguished from each other.

As shown in FIG. 3A, the optical path adjusting mechanism comprises plural beam splitters D11˜D15, which are arranged in parallel with each other. The source light beam L11 emitted from the light-emitting element L10 is successively transmitted through and reflected by the beam splitters D11˜D15, thereby generating the light beams LB11˜LB15.

As shown in FIG. 3B, the optical path adjusting mechanism comprises a polygonal reflective mirror D2. According to a rotating action R of the polygonal reflective mirror D2, the source light beam L21 emitted from the light-emitting element L20 is reflected by the polygonal reflective mirror D2, thereby generating the light beams LB21˜LB25.

As shown in FIG. 3C, the optical path adjusting mechanism comprises a polygonal reflective mirror D31 and an angle-amplifying lens D32. The angle-amplifying lens D32 is arranged in front of the polygonal reflective mirror D31. The source light beam L31 emitted from the light-emitting element L30 is reflected by the polygonal reflective mirror D31 and diverged by the angle-amplifying lens D32, thereby generating the light beams LB31˜LB35. Alternatively, the polygonal reflective mirror D31 may be replaced by a single-surface reflective mirror (not shown).

As shown in FIG. 3D, the optical path adjusting mechanism comprises a meniscus concave-convex lens D4. The source light beam L41 emitted from the light-emitting element L40 is diverged by the meniscus concave-convex lens D4, thereby generating the light beams LB41˜LB45.

As shown in FIG. 3E, the light-generating module 43 comprises two light-emitting elements L501˜L502. Similarly, the optical path adjusting mechanism comprises a meniscus concave-convex lens D5. The source light beams L511˜L512 emitted from the light-emitting element L501˜L502 are diverged by the meniscus concave-convex lens D5, thereby generating the light beams LB51˜LB55.

The light beams LB11˜LB15, LB21˜LB25, LB31˜LB35, LB41˜LB45, LB51˜LB55 are not interfered with each other. Alternatively, the light beams LB11˜LB15, LB21˜LB25, LB31˜LB35, LB41˜LB45, LB51˜LB55 may be interfered with each other in a staggered manner.

As shown in FIG. 3F, the optical path adjusting mechanism is omitted, but the light-generating module 43 comprises plural light-emitting elements L601˜L605. Moreover, the collimation source light beams L611˜L615 emitted from the light-emitting element L601˜L605 may be directed at different emergence angles or parallel with each other. The collimation light source is arranged so the light layer will not interfere with the display surface. No signal can be detected without any object touching the display surface.

Please refer to FIG. 2B. Once the physical object F (e.g. a single finger or multiple fingers) is intervened into the sheet-like light beam layer 42, these light beams (LB11˜LB15, LB21˜LB25, LB31˜LB35, LB41˜LB45, LB51˜LB55, L611˜L615) are sheltered by the physical object F, so that the light spot with a reflective bright border is resulted from the touching action of the physical object F. As a consequence, the touching action of a single finger or multiple fingers of the user becomes conspicuous. In addition, the light spot with a reflective bright border is helpful for identifying and inputting the pointing information (e.g. mouse left/right button, light spot position, light spot size and/or touching pressure), thereby providing better judgment.

FIG. 4 is a schematic side view illustrating a pointing input system according to a second embodiment of the present invention before a touch input operation is performed. As shown in FIG. 4, the pointing input system 50 comprises a side-looking display screen 51, a sheet-like light beam layer 52 including plural light beams, a light-generating module 53 for generating the sheet-like light beam layer 52, and a detector 54 (e.g. a video camera, a linear array or an optical receiver). The detector 54 is arranged at the upper left side and/or the upper right side of the display screen 51. The configurations and positions of the light-generating module 53 and the method of generating the light beams by the light-generating module 53 are similar to the light-generating module 43 of FIGS. 2A˜2B, and are not redundantly described herein. In addition, the detector 54 has a detecting beam range between the boundary lines I51.

The sheet-like light beam layer 52 abuts the display screen 51 and distributed on the surface of the display screen 51. The specified design should assure that, before a physical object F enters the sheet-like light beam layer 52 (see FIG. 2B), none of obvious reflective beams are received or captured by the detector 54. On the other hand, once the physical object F is intervened into the sheet-like light beam layer 52, the interference between the physical object F and the sheet-like light beam layer 52 results in a light spot, which is composed of several reflective beams.

A preferred embodiment of the light-generating modules 43 is shown in FIG. 3F. The light-generating module 43 comprises plural light-emitting elements L601˜L605 as the light source. Moreover, the source light beams L611˜L615 emitted from the light-emitting element L601˜L605 are parallel with each other. One of features of the present invention is to use laser light sources to form a sheet-like light beam layer as a touching sensitive region. Due to good optical characteristics, such as good collimation, it is advantageous to use laser to form such a light layer in a thin and flat configuration. Furthermore, any reflection or other noises may be reduced or eliminated by use of laser light sources. Even for specific designs, only simple optical collimation system may be equipped if necessary, which may reduce the cost of the pointing input system.

In views of power-saving efficacy and cost-effectiveness, the pointing input system may comprise an additional optical path adjusting mechanism (not shown). By the additional optical path adjusting mechanism, the light beams (LB11˜LB15, LB21˜LB25, LB31˜LB35, LB41˜LB45, LB51˜LB55) may be guided to an action region for detecting the physical object F. That is, these light beams are guided to the sensing range for sensing the physical object F. In this situation, before the physical object F enters the action region, the light beams could be recycled and reused in order to achieve the power-saving and cost-effective purposes. In some embodiments, the additional optical path adjusting mechanism comprises plural flat reflective mirror or plural curve reflective mirrors.

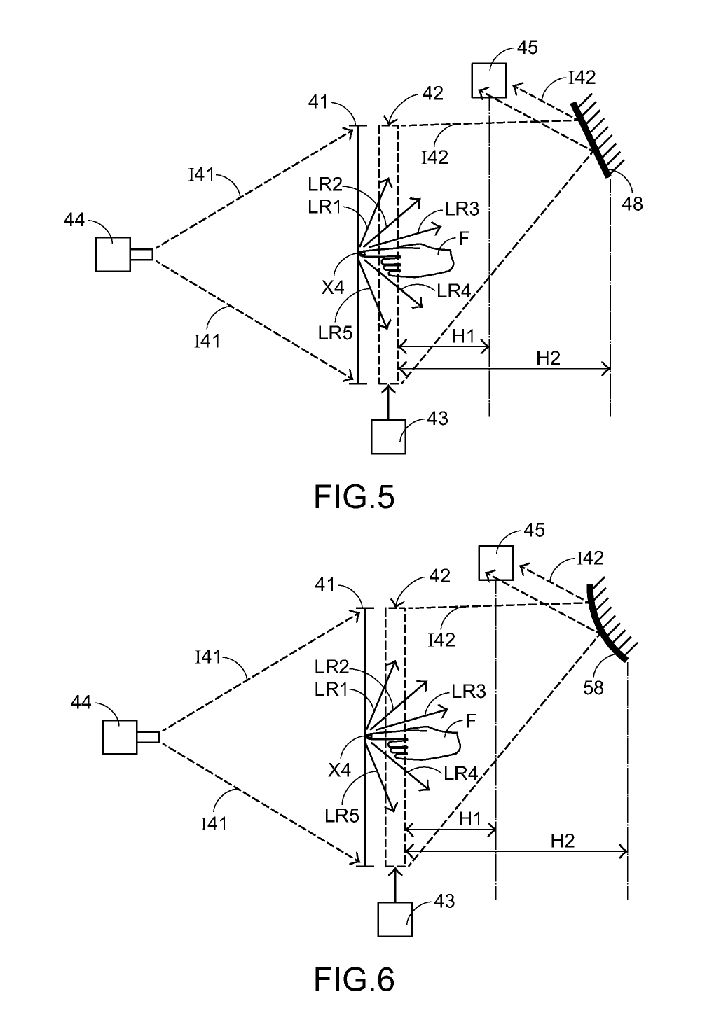

FIG. 5 is a schematically top-view diagram illustrating an exemplary pointing input system applied to short throw or ultra short throw projection environment. The overall distance of this system from screen the mirror is then minimized. Please refer to FIG. 5, that differs from one shown in FIG. 2B is a flat reflective mirror 48 deposited in front of the sheet-like light beam layer 42. The flat reflective mirror 48 is configured to, before the detector 45, receive the reflective beams LR1˜LR5 that result from the interference between the physical object F and the sheet-like light beam layer 42. The flat reflective mirror 48 is further configured to then reflect the several reflective beams LR1˜LR5 towards the detector 45. Thus, from top-view side, the detector 45 may be bias deposited in front of the sheet-like light beam layer 42. The vertical distance H1 between the detector 45 and the sheet-like light beam layer 42 may be shorter than where the detector 45 directly receives the reflective beams LR1˜LR5. The overall length of H2 becomes shorter. It is advantageous that the distance between the detector 45 and the sheet-like light beam layer 42 is shortened.

FIG. 6 is a schematically top-view diagram illustrating an exemplary pointing input system applied to large-scale projection environment. Please refer to FIG. 6, that differs from one shown in FIG. 5 is to replace the flat reflective mirror 48 by a curve reflective mirror 58. The curve reflective mirror 58 is in a suitable position in front of the sheet-like light beam layer 42 and bulged towards the sheet-like light beam layer 42. The function of the flat reflective mirror in FIG. 5 may be implemented by use of the curve reflective mirror 58, and the curve reflective mirror 58 may be advantageous to cover wider range with respect to the sheet-like light beam layer 42, even the interference generates at the corner of the sheet-like light beam layer 42. Thus, the reflective beams LR1˜LR5 reach to the curve reflective mirror 58 first, and then are received by the detector 45.

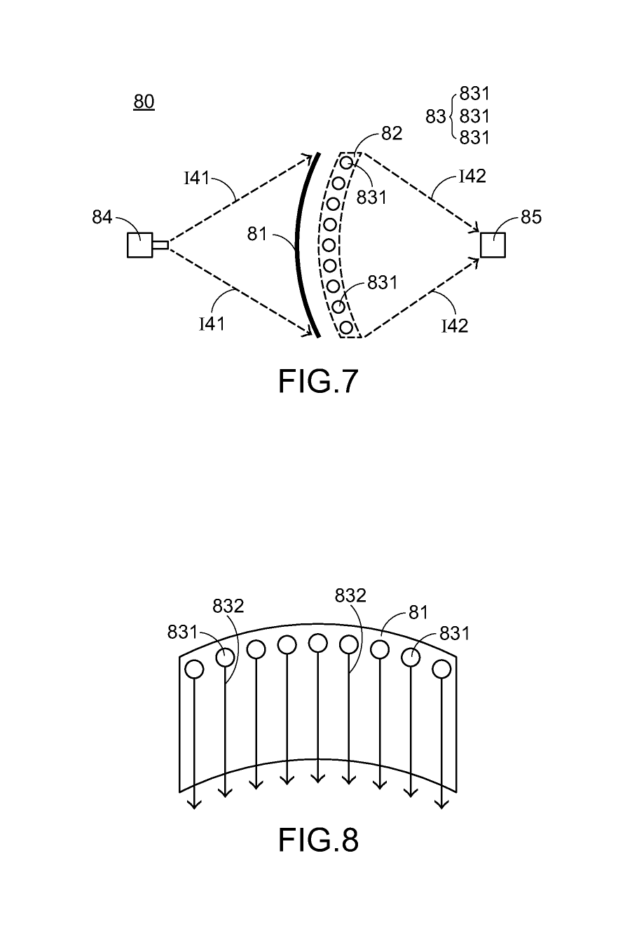

FIG. 7 is a schematically top-view diagram illustrating an exemplary pointing input system applied to large-scale display environment. FIG. 8 is a front-view diagram of a display screen and a light-generating module shown in FIG. 7. Please refer to FIG. 7, an exemplary pointing input system 80 includes a curve display screen 81, a curve sheet-like light beam layer 82 comprising several light beams, a light-generating module 83 generating the curve sheet-like light beam layer, a display 84 and a detector 85. In this embodiment, the curvatures of the curve display screen 81 and the curve sheet-like light beam layer 82 are similar, and both of them may be bulged or concave towards the detector 85. Next, the light-generating module 83 includes multitudes separated deposited laser light sources 831 to emit visible or invisible laser light beams 832 that form the curve sheet-like light beam layer 82. These laser light sources 831 may be aligned along with the curve edge (upper side or lower side) of the curve display screen 81, such that the curvature of the curve sheet-like light beam layer 82 consisting of the laser light beams 832 is same or similar to one of the curve display screen 81. It is understood that a flat or curve reflective mirror shown in FIG. 5 and FIG. 6 may be arranged in the system of FIG. 7. Moreover, another optical path adjusting mechanism may be equipped to be associated with the laser light sources at both sides of the curve edges of the display screen 81 to distribute the laser light beams over the curve display screen.

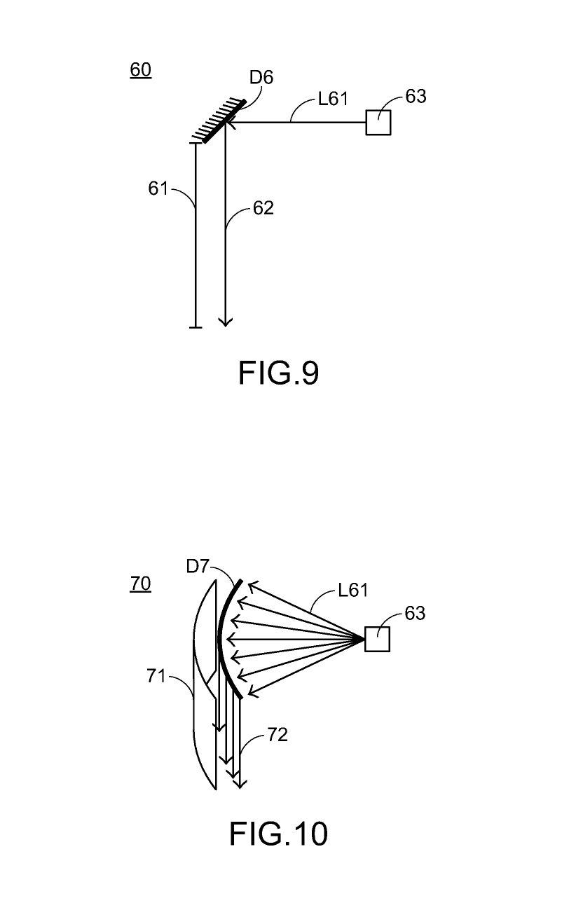

FIG. 9 is a schematically side-view diagram illustrating a portion of an exemplary pointing input system equipped with an optical path adjusting mechanism according to the present invention. FIG. 10 is a schematically top-side through view diagram illustrating a portion of an exemplary pointing input system equipped with an optical path adjusting mechanism and a curve display according to the present invention. Please refer to FIG. 9, the pointing input system 60 is equipped with a flat display 61 and a reflective mirror D6 as an optical path adjusting mechanism. A light-generating module 63 is deposited in front of the flat display 61 and emits source laser beams L61 towards the reflective mirror D6. The reflective mirror D6 may reflect those laser light source beams to form parallel laser light beams 62 abutting parallel to the surface of the flat display 61. These laser light beams 62 form the sheet-like light beam layer of the present invention. Either source laser beams L61 or laser light beams 62 are not directly incident into a detector (not shown) and detected by the detector before any interference generates within the sheet-like light beam layer.

Similarly, different from the pointing input system 60, the pointing input system 70 in FIG. 10 is equipped with a curve display 70 and an optical path adjusting mechanism D7 at the curve side of the curve display 70. The light-generating module 63 may emit plural source laser beams L61 that do not intersect each another, and the optical path adjusting mechanism D7 may receive the plural source laser beams L61 and guide them to form laser light beams 72 abutting parallel to the curve surface of the curve display 71. It is understood that the position of a detector for the pointing input systems 60 or 70 may be applied like ones shown in FIG. 2A, FIG. 2B, FIG. 4 and FIGS. 5-8.

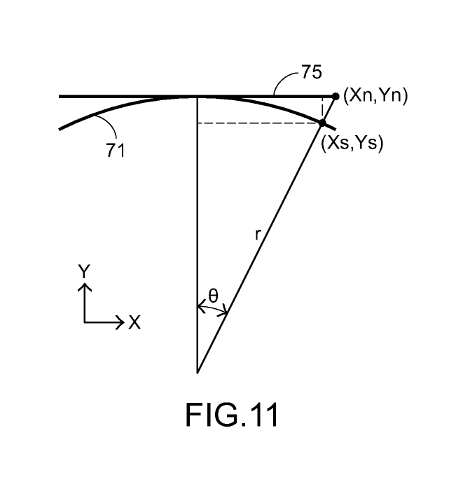

It is noted that distortion correction may be applied in the present invention, such as an appropriate numerical method to correct image distortion. FIG. 11 is a schematically diagram illustrating the distortion correction according to the present invention. When the curve display 71 is equipped, user may interfere the sheet-like light beam layer at the position (Xs, Ys), which may represent in the form of the radius r of the curve display 71 and the angle θ (theta) with respect to the center of the curve display 71. However, the corresponding un-distortion position read-out by the detector will be the position (Xn, Yn) just like one on a flat display 75. In this situation, Yn will be equal to Ys, and Xs will be shown as follows:
Xs=Xn−[(r/cos(θ))−r]*tan(θ). Thus, a distortion correction for a curve display may be done.

Accordingly, the pointing input system of the present invention can be applied from medium to a large-scale display system, for example, the display screen in the dimension of 30˜300 inches in diagonal of a computer screen, television screen, handwriting board screen, a multi-screen video wall or a projection screen, and the pointing input system can be set in space around the display screen. Next, the flat or curve sheet-like light beam layer has an even thickness, such as about 1˜5 mm and has a size in the dimension of 30˜300 inches in diagonal. The advantageousness by using laser light sources to form flat or curve sheet-like light beam layer include the reduction of noises, the acquisition of detectable interference signals, and the acquisition of sheet-like light beam layer in an even thickness.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A pointing input system, applied to a display screen, comprising:
a sheet-like light beam layer abutting the display screen and distributed on a surface of the display screen, wherein said sheet-like light beam layer comprises plural laser light beams emitted by a laser-generating module; and
a detector locates at a position subject to prevent from receiving said laser light beams from said laser-generating module, wherein when a physical object is intervened into said sheet-like light beam layer to form a light spot composed of plural reflective beams by sheltering said laser light beams of said sheet-like beam layer, said detector detects said light spot for detecting a pointing position with respect to said display screen.

2. The pointing input system according to claim 1 wherein said sheet-like light beam layer is flat or curve.

3. The pointing input system according to claim 1,
wherein said laser-generating module abutting a specified corner of said display screen, or
wherein said two laser-generating modules respectively arranged on a left corner and a right corner of said display screen, or respectively arranged at one of an upper side and a lower side of said display screen and one of a left side and a right side of said display screen.

4. The pointing input system according to claim 1, wherein said laser-generating module comprises:
a plurality of laser light sources abutting said surface of said display screen to generate a plurality of source laser beams; and
an optical path adjusting mechanism arranged corresponding to said laser light sources for reflecting and/or refracting said source laser beams, thereby generating said laser light beams of said sheet-like light beam layer.

5. The pointing input system according to claim 4, wherein said optical path adjusting mechanism comprises plural beam splitters arranged in parallel with each other, so that said source laser beams are successively transmitted through and reflected by said beam splitters to generate said laser light beams, or wherein said optical path adjusting mechanism comprises a polygonal reflective mirror, which is rotated to reflect said source laser beams, thereby generating said laser light beams, or wherein said optical path adjusting mechanism comprises a single-surface reflective mirror, which is rotated to reflect said source laser beams, thereby generating said laser light beams, or wherein said optical path adjusting mechanism comprises a meniscus concave-convex lens.

6. The pointing input system according to claim 1, wherein said sheet-like light beam layer has an even thickness in a range of 1 to 5 mm, and a diagonal dimension of 30 to 300 inches.

7. The pointing input system according to claim 1, further comprising a flat or curve reflective mirror deposited in front of said sheet-like light beam layer to receive said plural reflective beams and transmit said plural reflective beams to said detector.

8. The pointing input system according to claim 1, wherein said detector comprises a single video camera in front of said sheet-like beam layer to be not aligned along with said laser light beams of said sheet-like beam layer such that said video camera does not detect said plural laser light beams emitted by said laser-generating module.

9. The pointing input system according to claim 8, wherein said sheet-like light beam layer is a flat sheet-like light beam layer.

10. The pointing input system according to claim 9,
wherein said laser-generating module comprising plural laser light sources abutting a specified corner of said display screen and generating plural source laser beams, or
wherein said multiple laser-generating modules respectively comprising plural laser light sources to be arranged on a left corner and a right corner of said display screen, or respectively arranged at one of an upper side and a lower side of said display screen and one of a left side and a right side of said display screen.

11. The pointing input system according to claim 10, further comprising an optical path adjusting mechanism arranged corresponding to said laser light sources for reflecting and/or refracting said source laser beams, thereby generating said laser light beams of said sheet-like light beam layer.

12. The pointing input system according to claim 9, further comprising a flat or curve reflective mirror deposited in front of said sheet-like light beam layer to receive said plural reflective beams and transmit said plural reflective beams to said single video camera, wherein for a vertical distance with respect to said sheet-like light beam layer, said single video camera is shorter than said flat or curve reflective mirror.

13. The pointing input system according to claim 8, wherein said sheet-like light beam layer is a curve sheet-like light beam layer and said display screen is a curve display screen.

14. The pointing input system according to claim 13, wherein said laser-generating module comprises plural laser light sources respectively arranged along with one or two curve edges of said curve display screen.

15. The pointing input system according to claim 14, further comprising an optical path adjusting mechanism arranged corresponding to said laser light sources for reflecting and/or refracting said source laser beams, thereby generating said laser light beams of said sheet-like light beam layer.

16. The pointing input system according to claim 15, further comprising a flat or curve reflective mirror deposited in front of said sheet-like light beam layer to receive said plural reflective beams and transmit said plural reflective beams to said single video camera, wherein for a vertical distance with respect to said sheet-like light beam layer, said single video camera is shorter than said flat or curve reflective mirror.

17. The pointing input system according to claim 1 wherein said physical object includes a finger, multiple fingers or a stick-like article.

18. The pointing input system according to claim 1 wherein said display screen is a computer screen, television screen, handwriting board screen, a multi-screen video wall or a projection screen.

19. The pointing input system according to claim 1 wherein when said pointing input operation is performed, pointing information associated with mouse left/right button, light spot position, light spot size and/or touching pressure is simultaneously identified and inputted.

20. The pointing input system according to claim 1, wherein said pointing position detected by said detector is implemented by a distortion correction with respect to said display screen.
